(19) United States
(12) Patent Application Publication
(10) Pub. No.: US 2004/0062236 A1
(43) Pub. Date: Apr. 1, 2004

(54) Method of chatting through a cellular phone system

(76) Inventors: Fu-Zu Lee, Shanghai (CN); Dai-Shui Ho, Taipei Hsien (TW); Shih-Kuang Tsai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,293

(22) Filed: Oct. 1, 2002

(51) Int. Cl. H04L 12/66

(52) U.S. Cl. 370/356; 370/352

(57) ABSTRACT

A method of chatting through a cellular phone system is disclosed. The cellular phone system includes a processor connected to an Internet website that supports network chatting, and a plurality of nodes. The method includes wirelessly connecting a plurality of cellular phones to the website via the plurality of nodes and the processor, sending a message by a cellular phone of the plurality of cellular phones to the website through a node of the plurality of nodes and the processor, and sending the message from the website to the plurality of cellular phones via the processor and the plurality of nodes.

### BACKGROUND OF INVENTION

1. Field of the Invention

The present invention relates to a method for chatting via a cellular phone system. More specifically, a method of chatting with other users who connect to a website through cellular phones of a cellular phone system for connecting to the website is disclosed.

2. Description of the Prior Art

As communication technology rapidly develops, cellular phones have become very important communication tools. Short message services (SMS) provided by cellular phone systems can provide a faster, cheaper, and more convenient chatting method.

Referring to FIG. 1. FIG. 1 is a schematic diagram of a short message service of a conventional GSM cellular phone system 10. When a user 16 sends a message to another user 32, a procedure occurs as follows:

1) A user 12 utilizes a cellular phone 14 to send a message 16 to a corresponding base station 18 (the message 16 includes what the user 12 wants to send and a cellular phone number of the user 32);

2) The message is sent from the base station 18 to a short message service center 22;

3) The short message service center 22 is connected with a GSM network 30 via a specific GSM mobile switching center (MSC) 20;

4) The GSM mobile switching center 20 locates a corresponding GSM mobile switching center 40 where the present user 32 is based on a GSM roaming protocol, and the message 16 is sent to the GSM mobile switching center 40;

5) The GSM mobile switching center 40 sends the message 16 to the base station 38 where a cellular phone 34 belonging to the user 32 is located;

6) The base station 38 sends messages to all cellular phones including the cellular phone 34 under the base station 38 (the user 32 not only receives the message 16 but also where the message 16 is sent from, because the display of the cellular phone 34 shows the cellular phone number of the user 12).

There is little doubt that utilizing the cellular phone 14 to send messages 16 is convenient, however the disadvantage of this method is that the user 12 has to know the cellular phone number of the user 32 in advance to sending messages 16. If the user 12 wants to make a new friend or to discuss the latest fashion trends with a stranger, but does not want the stranger to know his cellular phone number, the above method is unable to satisfy this requirement. However, a computer network does have this capability.

The present technology network has a variety of chat rooms for allowing users to make new friends or to discuss topics with other users. Please refer to FIG. 2 illustrating a schematic diagram of a conventional network system. When a user enters a website having a chat function and chats with another user, the following procedure occurs:

1) A user 42 utilizes a personal computer 44 to connect to a chat room provided in a website 50. After registering with the chat room, the user 42 operating the computer 44 can simultaneously chat with a user 52 operating another computer 54 who also connects to the chat room provided in the website 50;

2) The user 42 operating the computer 44 sends chat content 46 to the website 50 via a network system 48. At the same time, the user 52 operating the computer 54 also sends chat content 56 to the website 50 via the network system 48.

3) After receiving the content 46 from the user 42 and the content 56 from the user 52 in turn, the website sends the chat contents 56, 46 to the computers 44, 54 operated by the user 42, 52 respectively, via the network system 48.

In addition, the above network system permits more than two users to connect to the website 50 simultaneously.

Although the above network system 48 is capable of allowing users to chat privately, users must own and be willing to use computers to enjoy this function.

### SUMMARY OF INVENTION

The purpose of the claimed invention is to provide a method for a user to connect to a website using a cellular phone or other communication device via a cellular phone system to allow chatting with other users connected to the website.

The claimed invention is a method of chatting through a cellular phone system. The cellular phone system includes a processor connected to an Internet website that supports network chatting, and a plurality of nodes. The method includes wirelessly connecting a plurality of cellular phones to the website via the plurality of nodes and the processor, sending a message by a cellular phone of the plurality of cellular phones to the website through a node of the plurality of nodes and the processor, and sending the message from the website to the plurality of cellular phones via the processor and the plurality of nodes.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a short message service of a conventional GSM cellular phone system where a user sends a message to another user.

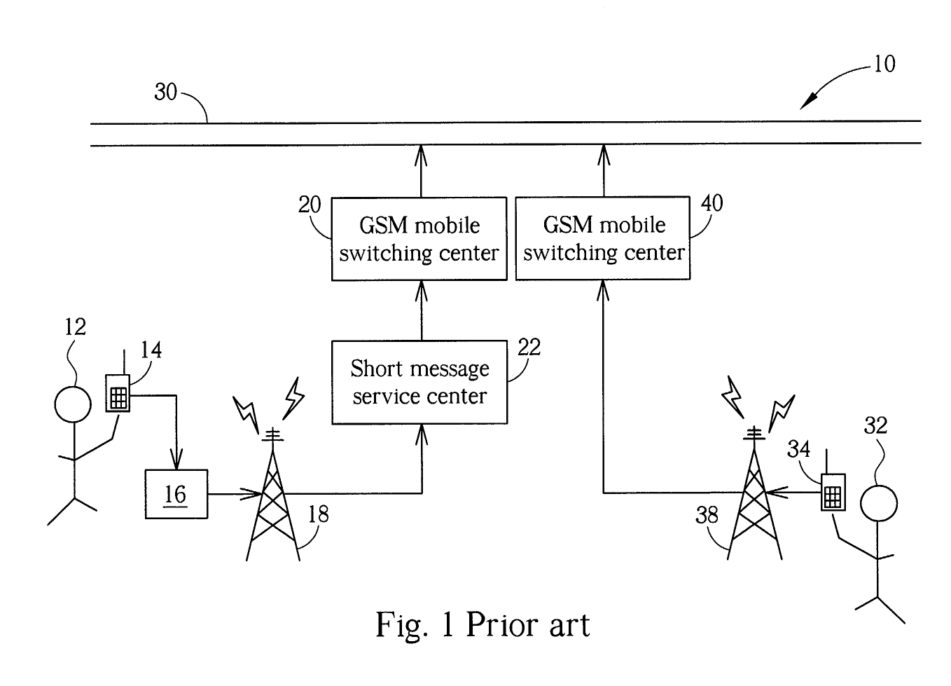

FIG. 2 is a schematic diagram of a conventional network system where a user enters a website with a chat function and chats with another user.

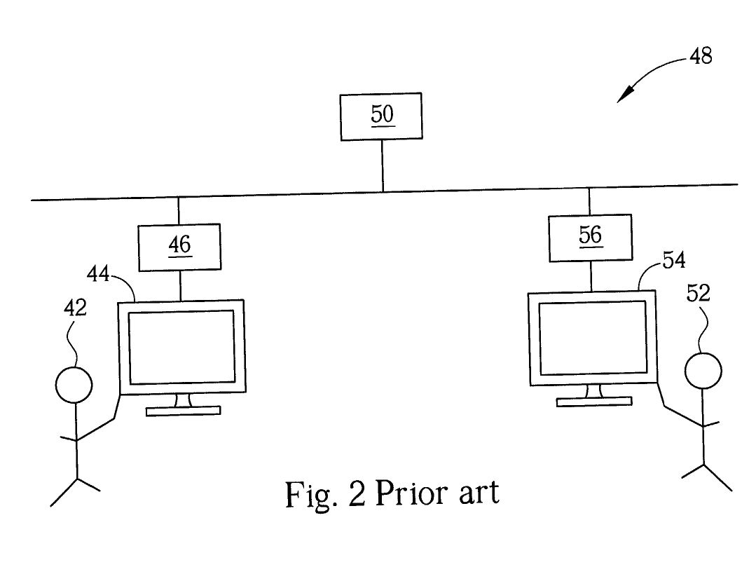

FIG. 3 is a schematic diagram of a cellular phone system according to the present invention.

FIG. 4 is a flowchart of chatting through the cellular phone system of FIG. 3.

### DETAILED DESCRIPTION

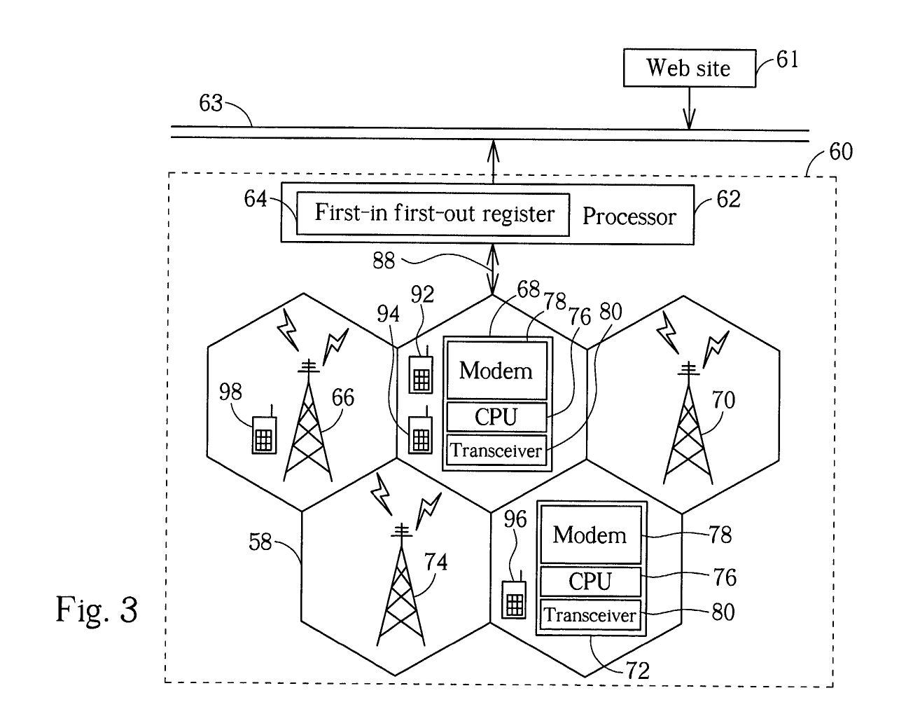

Please refer to FIG. 3. FIG. 3 is a schematic diagram of a cellular phone system 60 according to the present invention. The cellular phone system 60 comprises a processor 62, being a mobile switching center, connected to a website 61 having a chat room via a network 63 and also connected to processors in other phone systems or communication devices in other communication systems. The phone system 60 further includes a public service telephone network (PSTN) 88, a plurality of cellular base station 66, 68, 70, 72, and 74 each connected to the processor 62 and connected with each other via cables, optical fibers or microwaves, and a plurality of cellular phones (stations) 92, 94, 96, and 98. The processor 62 comprises a first-in-first-out register 64 for storing data 90 delivered from each cellular phone. Each base station comprises a transceiver 80 for receiving the data 90 from the cellular phones of the base station, a CPU 76 for processing the data 90 from the transceiver 80, and a modem 78 for transforming the data 90 from digital to analog. Each base station in each cell is in charge of receiving or delivering wireless signals, providing a reliable communication pathway between the cellular phones and the base stations, distributing the resource of the wireless pathway, and controlling a handover program between each base station. The larger an emitting power of an antenna from the base station in the cell is, the larger a scope of the cell is. As a result of more obstacles in urban areas, the scope of the cell in urban areas is smaller. On the contrary, the scope of the cell in suburban areas is larger. In the present invention, it is assumed that the scopes of all the cells are equivalent. Each of the plurality of cellular phones 92, 94, 96 and 98 of the cellular phone system has a memory for storing phone numbers of chatting websites and previous chat records. A user can dial the phone numbers stored in the memory to connect to the chatting websites 61 quickly and can store the chatting contents in the memory.

Each cellular phone within a cell exchanges data wirelessly with the base stations within the same cell and each base station exchanges data in a wired manner with the processor 62. For example, the cellular phone 92 is required to send data 90 to the cellular phone 96. The cellular phone 92 transfers the data 90 wirelessly to the base station 68, the transceiver 80 in the base station 68 sends the data 90 to the CPU 76 after receiving the data 90 from the cellular phone 92, the CPU 76 sends the processed data 90 to the modem 78 for transforming the data 90 from digital to analog, and the modem 78 sends the analog data 90 to the processor 62 in a wired manner. Then, the processor 62 sends the data 90 to the base stations 66, 68, 72 where the cellular phones 92, 94, 96, 98 are located in a wired manner based on information within the data 90. Similarly, the modems 78 in the base stations 66, 68, 72 transform the data 90 from the processor 62 into digital form, and send the digital data 90 to the CPUs 76. Finally, the CPUs 76 send the digital data 90 to the cellular phones 92, 94, 96, 98 via the transceivers 80 in a wireless manner.

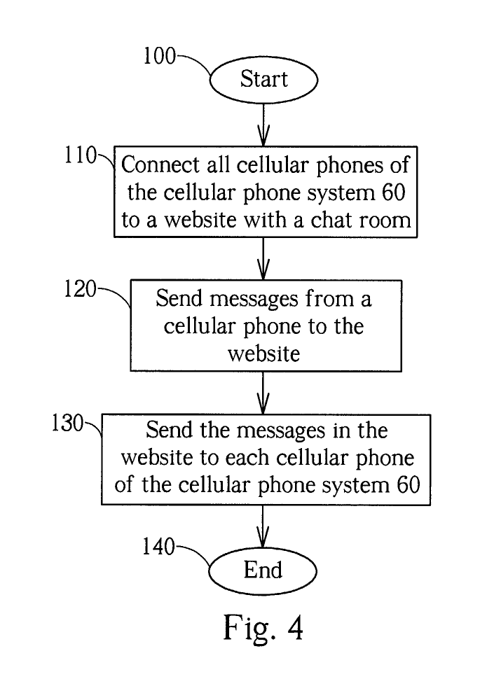

Please refer to the FIG. 4. FIG. 4 is a flowchart of the present invention method of chatting through the cellular phone system 60. The steps of the flowchart of FIG. 4 are described as follows:

Step 100:

Start (Each cellular phone is an user of the cellular phone system 60, in other words, each cellular phone has passed a registration procedure and a certificate procedure from the processor 62 before sending data to the processor 62.);

Step 110:

Each of the cellular phones 92, 94, 96, and 98 connect wirelessly to their respective base stations 66, 68, 72 and connect to the website 61 having a chat room via the processor 62 (In the preferred embodiment, the plurality of the cellular phones 92, 94, 96, 98 connects to the website 61 via the processor 62 simultaneously.);

Step 120:

A message from one of the cellular phones is sent to a base station corresponding to the cellular phone in a wireless manner, and the base station sends the message to the website 61 via the processor 62 (As in the previous example, the cellular phone 92 sends the data 90 to the base station 68 in a wireless manner, the base station 68 sends the data 90 to the website 61 via the processor 62. If other cellular phones send messages simultaneously, these messages including the message from the cellular phone 92 are sent through the first-in-first-out register 64 of the processor 62 and then sent to the website 61 in turn.);

Step 130:

The data 90 and other messages in the website 61 are sent to the plurality of base stations via the processor 62, and each base station sends the messages to the cellular phones corresponding to the base stations (Other messages in the website 61 can be from other cellular phone systems or other communication devices. In the current communications environment, the cellular phones 92, 94, 96, 98 of the cellular phone system 60 can receive messages from other communication devices from as far away as 3000 miles.);

Step 140:

End (The user of the cellular phone 92 terminates the chat with the other cellular phones 94, 96, 98.).

In contrast to the prior art, the present invention of chatting with the cellular phone system has the character of mobility, privacy, and worldwide access so that the user can use his own cellular phone freely to chat with his friends or anonymously with others while not being afraid of leaking his personal identity.

Those skilled in the art will readily observe that numerous modifications and alterations of the method may be made while retaining the teachings of the invention. Accordingly, the above disclosure should be construed as limited only by the metes and bounds of the appended claims.

1. A method of chatting via a cellular phone system comprising a processor connected to an Internet web which supports network chatting, and a plurality of nodes connected to the processor for wirelessly communicating with a plurality of cellular phones, the method comprising:
connecting the plurality of cellular phones wirelessly to the plurality of nodes, and connecting to the Internet web via the processor;
sending a message from one of the plurality of cellular phones wirelessly to one of the plurality of nodes, and sending the message from the node to the Internet web via the processor; and
sending the message via the processor to the plurality of nodes, and sending the message from the plurality of nodes to the plurality of cellular phones.

2. The method of claim 1 wherein the plurality of nodes are base stations.

3. The method of claim 1 wherein the processor comprises a register for holding messages from the plurality of cellular phones in turn.

4. The method of claim 3 wherein the register is a first-in-first-out (FIFO) memory.

5. The method of claim 1 wherein the processor is a mobile switching center.

6. The method of claim 1 wherein each cellular phone comprises a memory for storing a plurality of phone numbers and data sent from the processor via the corresponding nodes.
